(19) United States
(12) Patent Application Publication
(10) Pub. No.: US 2008/0159149 A1
(43) Pub. Date: Jul. 3, 2008

(54) Prioritized bandwidth management method for switch

(75) Inventor: Michitaka Okuno, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd

(21) Appl. No.: 11/878,279

(22) Filed: Jul. 23, 2007

(30) Foreign Application Priority Data
Dec. 27, 2006 (JP) 2006-350847

(51) Int. Cl. G08C 15/00

(52) U.S. Cl. 370/237

(57) ABSTRACT

In a congestion state where a specific destination in a switch fabric is congested, high priority data is allowed to pass at a low delay or high throughput while in a non-congestion state where the specific destination in the switch fabric is not congested, full use of switching bandwidth is made regardless of priority. In a switch fabric which includes plural transmitting source nodes each having not less than two output queues by the priority on a destination-by-destination basis, a switch for evenly distributing data units delivered from the plurality of the transmitting source nodes on the destination-by-destination basis, and plural destination nodes for receiving the data units from the switch, the respective transmitting source nodes assume that a relevant destination is in a congestion state when an available capacity of a receive-buffer of the switch, controlled by the respective transmitting source nodes, on the destination-by-destination basis, falls short of a set congestion threshold, thereby restricting data output from the output queues by the priority to the relevant destination up to a preset bandwidth according to priority while the respective transmitting source nodes assume that the congestion state of the relevant destination is dissolved when the available capacity of the receive-buffer of the switch, on the destination-by-destination basis, exceeds the set congestion threshold, thereby dissolving restriction on the bandwidth, according to the priority.

### CLAIM OF PRIORITY

The present application claims priority from Japanese application JP 2006-350847 filed on Dec. 27, 2006, the content of which is hereby incorporated by reference into this application.

### FIELD OF THE INVENTION

The invention relates to a switching technology for dynamically and mutually connecting plural functional blocks, existing in routers, servers, storage units and so forth, with each other, and in particular, to a technology for implementing prioritized bandwidth management on the basis of prioritized information added to data by utilizing plural switches that operate independently.

### BACKGROUND OF THE INVENTION

With a network transfer unit such as a router, a server, a storage unit for connecting plural disk arrays with each other, and so forth, a switch fabric is utilized for executing data switch between functional blocks within respective units. Since there are limitations to a switching bandwidth of the switch fabric, it is desirous to implement data switch according to priority when plural input data units converge on the same destination. That is, it is desired that high priority data be switched at a low delay or a high throughput.

With the network transfer unit, generally called the router, and a switch, when data called a packet or a frame is received from a network, priority of the data, within the unit, is decided upon by making use of header information of the data, and information on priority within the unit is added to the data. For example, voice data, video data, data passing through a specific path, and so forth are given high priority while data other than those data units is given low priority. Then, priority management is achieved by changing how to handle relevant data in the switch fabric within the unit by making use of the information on priority, as added.

A method for priority management in the switch fabric can be generally classified into two methods as follows. A first one is a method whereby a transmitting source node is provided with a function for prioritized bandwidth management. With this method, if priority is low, output is inhibited unless a certain threshold condition is met even in a status where data can be transmitted to a switching device. That is, lower delay or higher throughput of high priority data can be implemented by providing data input to the switch fabric with restrictions on output on a priority-by-priority basis. JP-A No. 2002-247080 is cited as a specific example representing this technology.

A second one is a method whereby a switching device in the switch fabric is provided with a function for selectively outputting priority data. With this method, arbitration of data output is executed in the switching device, in units of a packet of a variable length, or in units of a cell of a fixed length, the cell being a constituent of a packet, on a destination-by-destination basis. Lower delay or higher throughput of high priority data can be implemented by selectively outputting higher priority data on a preferential basis.

Those conventional methods, however, each have a problem. First, with the first method, because usable bandwidths are always limited according to priority, output of low priority data will be restricted even if the switch fabric is in a non-congestion state where the switch fabric is unoccupied when only low priority data exists. As a result, there arises a problem that a switching bandwidth of the switch fabric cannot be fully utilized.

Further, in US 20060104298 (A1), there has been described a method for executing bandwidth management by causing a switch to transmit information on where congestion has occurred, in the form of a command, to a transmitting side node when the switch fabric is in a status of congestion, in which case, it is necessary for the switch to have special workings for generating the command. Furthermore, as it takes some time for the command to reach the transmitting side node, this method somewhat lacks in quick responsiveness.

Then, with the second method, a portion of low priority data, transmitted from the transmitting side node to a switching device, is liable to be retained in the switching device, and such a phenomenon can cause a problem. For example, in the case where the switching device does not have independent primary data-holding regions by the priority, a problem occurs in that preceding low priority data interferes with proceeding of succeeding high priority data from the same transmitting source. In order to avoid such a problem, the switching device needs to have the independent primary data-holding regions by the priority on a transmitting source-by-transmitting source basis, resulting in an increase in hardware size, in proportion to the number of priorities, leading to an increase in hardware cost, so that a problem still remains.

Further, with the second method, in the case of data of a variable length being switched with a dispersion type switch wherein a switch with a switching throughput equivalent to 1/K of an object switching throughput, is prepared for each of K planes, all transmitting source nodes are connected to all destination nodes, respectively, against the respective switches on the K planes, and input data units are dispersed on respective switch planes so as to undergo parallel actions, the problem will be found pronounced. In order to simplify a hardware configuration, an operation is generally executed whereby the data of the variable length is divided into plural data units of a fixed length in the switch fabric before transmission, and the plurality of the data units are reassembled into the original data of the variable length at the destination.

At this point in time, if the switching device has the function for selectively outputting the priority data, when collision between high priority data and low priority data occurs on some of the switches on the K planes, the low priority data is left out in the switching device. Meanwhile, with the switches where collision has not occurred, the low priority data as it is will pass therethrough, so that there occurs a phenomenon where only a portion of the data of the variable length is retained in the respective switches. If this state continues, the transmitting side node will transmit data one after another by making use of unoccupied switch planes, resulting in occurrence of a phenomenon where succeeding low priority data overtakes preceding low priority data. Particularly, in the case of the number of the switch planes being numerous, or the number of the nodes being numerous, this problem has large influences. In order that the original data of the variable length is reproduced at the destination node, there is the need for queuing of all data units of the fixed length, making up the original data of the variable length, however, in a state where the retention of the data frequently occurs in the respective switches, described as above, the logic, and memory, for queuing of the retained data, will inevitably turn giant in magnitude, giving rise to a problem in terms of cost.

### SUMMARY OF THE INVENTION

A problem to be resolved is to allow high priority data to pass at a low delay or high throughput in a congestion state where a specific destination in the switch fabric is congested. At the same time, another problem to be resolved is to make full use of a switching bandwidth regardless of priority in a non-congestion state where the specific destination in the switch fabric is not congested.

In accordance with one aspect of the invention, with a switch fabric which includes plural transmitting source nodes each having not less than two output queues by the priority on a destination-by-destination basis, a switch for evenly distributing data units delivered from the plurality of the transmitting source nodes on the destination-by-destination basis, and plural destination nodes for receiving the data units from the switch, the respective transmitting source nodes assume that a relevant destination is in a congestion state when an available capacity of a receive-buffer of the switch, controlled by the respective transmitting source nodes, on the destination-by-destination basis, falls short of a set congestion threshold, thereby restricting data output from the output queues by the priority to the relevant destination up to a preset bandwidth according to priority while the respective transmitting source nodes assume that the congestion state of the relevant destination is dissolved when the available capacity of the receive-buffer of the switch, on the destination-by-destination basis, exceeds the set congestion threshold, thereby dissolving restriction on the bandwidth, according to the priority.

If the invention is put to use, this will enable high priority data to pass at a low delay or high throughput in the congestion state where the specific destination in the switch fabric is congested. At the same time, it is possible to make full use of the switching bandwidth regardless of priority in the non-congestion state where the specific destination in the switch fabric is not congested. Furthermore, it is possible to provide the workings of the prioritized bandwidth management with the use of hardware resources as small in scale as possible.

### BRIEF DESCRIPTION OF THE DRAWINGS

FIG. 1 is a block diagram showing a prioritized bandwidth management method according to the invention;

FIG. 2 is a block diagram of a switch fabric according to the invention;

FIG. 3 is a block diagram showing a conventional credit management method by way of example;

FIG. 4 is a block diagram showing the conventional credit management method by way of example;

FIG. 5 is a schematic illustration showing the prioritized bandwidth management method according to the invention, using the number of remained credits;

FIG. 6 is a schematic illustration showing the prioritized bandwidth management method according to the invention, using the number of the remained credits;

FIG. 7 is a flow chart showing a method for enabling the prioritized bandwidth management method according to the invention, and the prioritized bandwidth management method;

FIG. 8 is a flow chart showing a method for disabling the prioritized bandwidth management method according to the invention;

FIG. 9 is a block diagram showing one embodiment of a logic whereby the prioritized bandwidth management according to the invention is executed;

FIG. 10 is a graph showing a state of data output when the prioritized bandwidth management according to the invention is enabled;

FIG. 11 is a graph showing a state of switching throughput when the prioritized bandwidth management according to the invention is enabled; and

FIG. 12 is a graph showing a state of switching delay when the prioritized bandwidth management according to the invention is enabled.

### DETAILED DESCRIPTION OF THE PREFERRED EMBODIMENTS

Embodiments of the invention are described in more detail hereinafter with reference to the accompanying drawings.

### First Embodiment

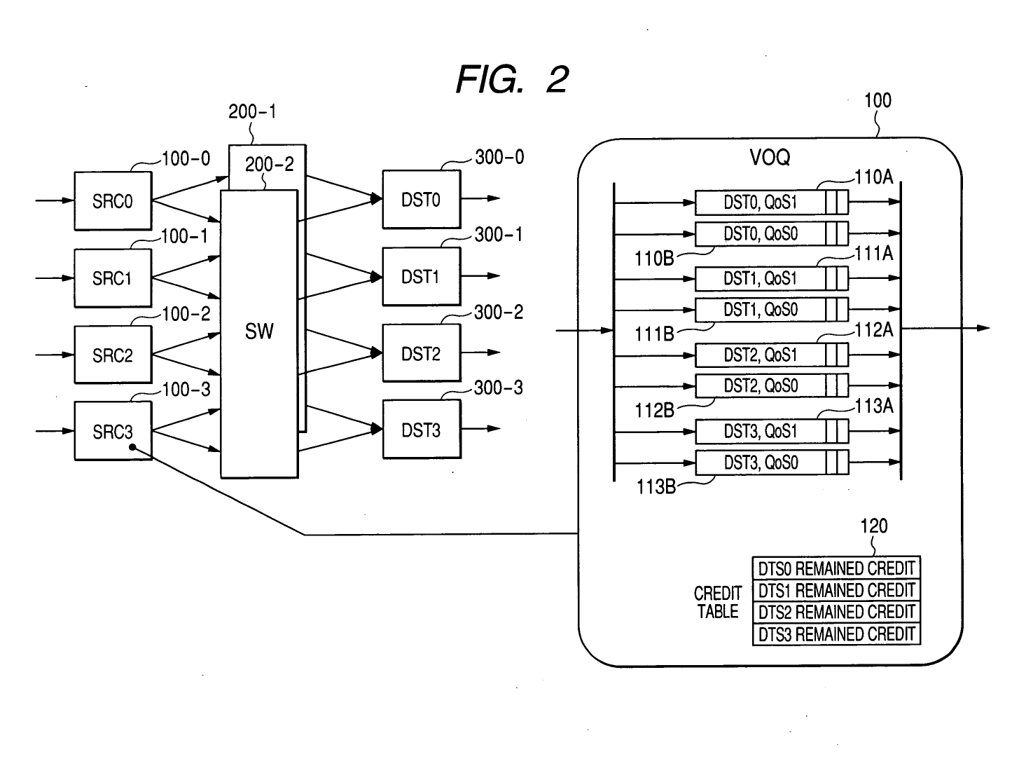

In FIG. 2, there is shown a first embodiment of a dispersion type switch configuration according to the invention as a small-scale switch fabric with four ports. The switch fabric is made up of transmitting source nodes 100-0 to 100-3, switches for executing data switch, 200-1 to 200-2, and destination nodes 300-0 to 300-3. In this case, the switches 200 each are assumed to be a very simple switch for evenly outputting all inputs on a destination-by-destination basis without execution of priority management. Further, in this case, it is predicated that the dispersion type switch 200 has two planes, however, it may a switch 200 with only one plane. Otherwise, it may a dispersion type switch 200 with three or more planes.

The transmitting source nodes 100 each have virtual output queue (VOQ: Virtual Output Queue) by the destination, and by the priority. In this case, the virtual output queues each have two classes of priorities, that is, high priority QoS1 VOQs 110A to 113A, and low priority QoS0 VOQs 110B to 113B. The VOQs 110A to 113A, and 110B to 113B each have an independent credit on a destination-by-destination basis regardless of priority on a credit table 120. Herein, the credit refers to an available capacity of a receive-buffer of the switch 200, provided on a transmitting source-by-transmitting source basis, and on a destination-by-destination basis. The VOQs 110A to 113A, and 110B to 113B, having the credit, respectively, can transmit data to the switch 200.

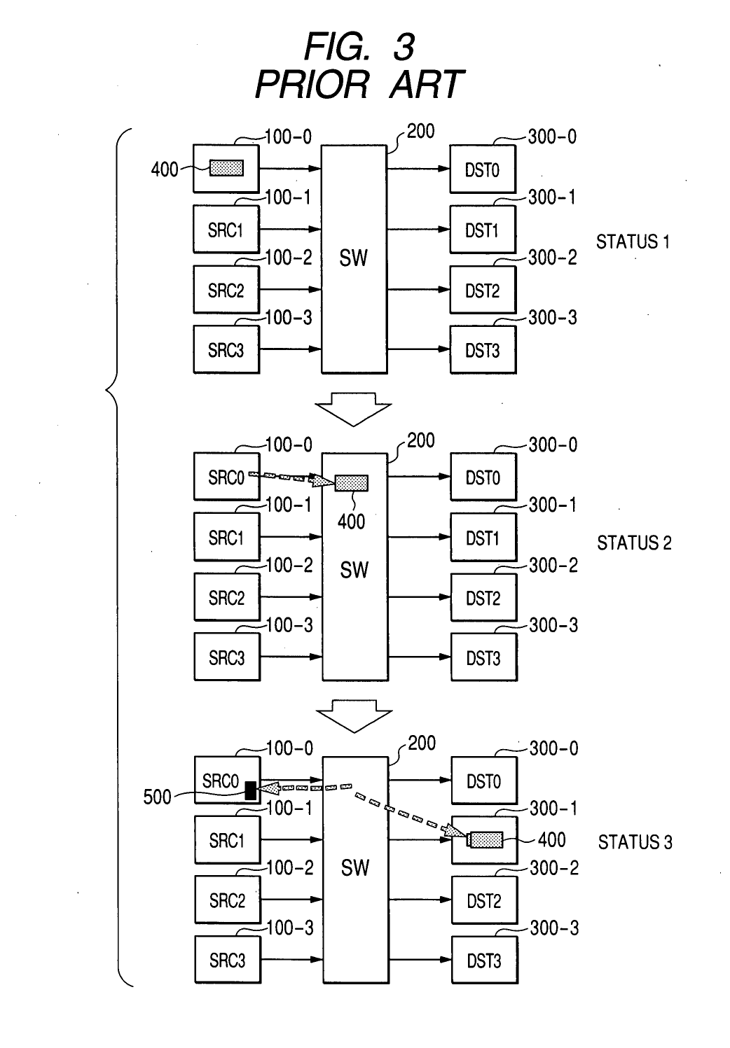

Now, common credit management by the switch fabric is described with reference to FIG. 3. FIG. 3 shows an example of a transmitting source node 100-0 transmitting data 400 to a destination node 300-1. In a status 1, the transmitting source node 100-0 checks an available buffer region of the destination node 300-1, for which a switch 200 itself acts as a transmitting source, that is, whether or not there remains a credit. If the credit is found remained, the transmitting source node 100-0 transmits the data 400 to the switch 200, and reduces the credit, thereby proceeding to a status 2. Subsequently, the switch 200 checks whether or not a credit remains in the destination node 300-1. If the credit is found remained, the switch 200 transmits the data 400 to the destination node 300-1, thereby reducing the credit for the destination node 300-1. Further, since a buffer region for the source node 100-0 in the switch 200 is available again, the switch 200 returns a recovery credit 500 to the transmitting source node 100-0 (a status 3).

As above-described, the transmitting source 100 can transmit data to a relevant destination as long as there remains a credit at the destination, for use by the switch 200. Every time data passes through the switch 200, the switch 200 returns a recovery credit to the relevant transmitting source of the data, thereby recovering the credit. Further, the switch 200 needs to have a buffer region corresponding to not less than time (RTT: Round Trip Time) required from transmission of the data until recovery of the credit by the transmitting source, and the transmitting source 100 has the number of credits, corresponding to the available capacity of the buffer, previously described. When data smoothly flows, there will continue a status where the number of the credits of the transmitting source 100, corresponding to the RTT, has been used up.

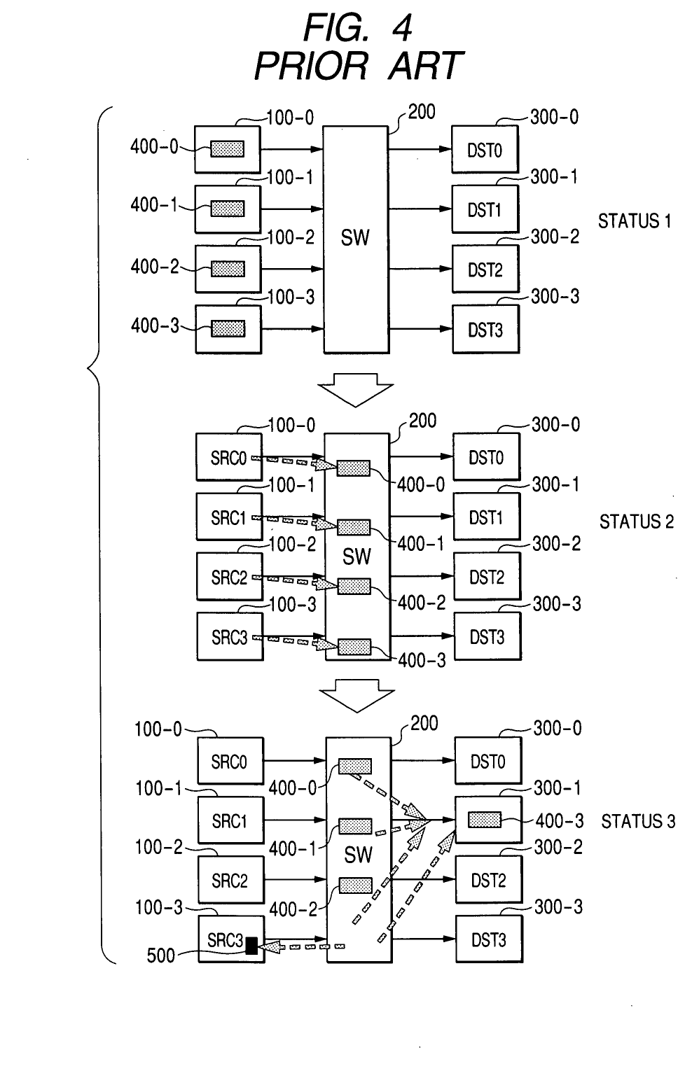

Further, a state where congestion occurs to the switch fabric is described with reference to FIG. 4. FIG. 4 shows an example where all the transmitting source nodes 100-0 to 100-3 each transmit data units 400-0 to 400-3 to the same destination node 300-1. In a status 1, the transmitting source nodes 100-0 to 100-3 each check an available buffer region of the destination node 300-1, for which a switch 200 itself acting as a transmitting source, that is, whether or not there remains a credit in the destination node 300-1. If the credit is found remained, the transmitting source nodes 100-0 to 100-3 each transmit the data units 400-0 to 400-3 to the switch 200, and reduces the credit, thereby proceeding to a status 2. Subsequently, the switch 200 checks whether or not there remains a credit in the destination node 300-1. If the credit is found remained, the switch 200 selects one of the data units 400-0 to 400-3 to be then transmitted to the destination node 300-1, reducing the credit for the destination node 300-1. With this example, the data unit 400-3 of the transmitting source node 100-3 is selected, so that the transmitting source node 100-3 comes to have an available buffer region again, and the switch 200 returns a recovery credit 500 to the transmitting source node 100-3 (a status 3).

If the statuses shown in FIG. 4 continue, return of the recovery credit to the respective transmitting source nodes 100 will come to be delayed and the respective transmitting source nodes 100 will come to be lacking in credit, resulting in frequent occurrences of a status where data cannot be transmitted, so that the relevant destination of the switch fabric will be in a status of congestion. Description of the common credit management is completed as above.

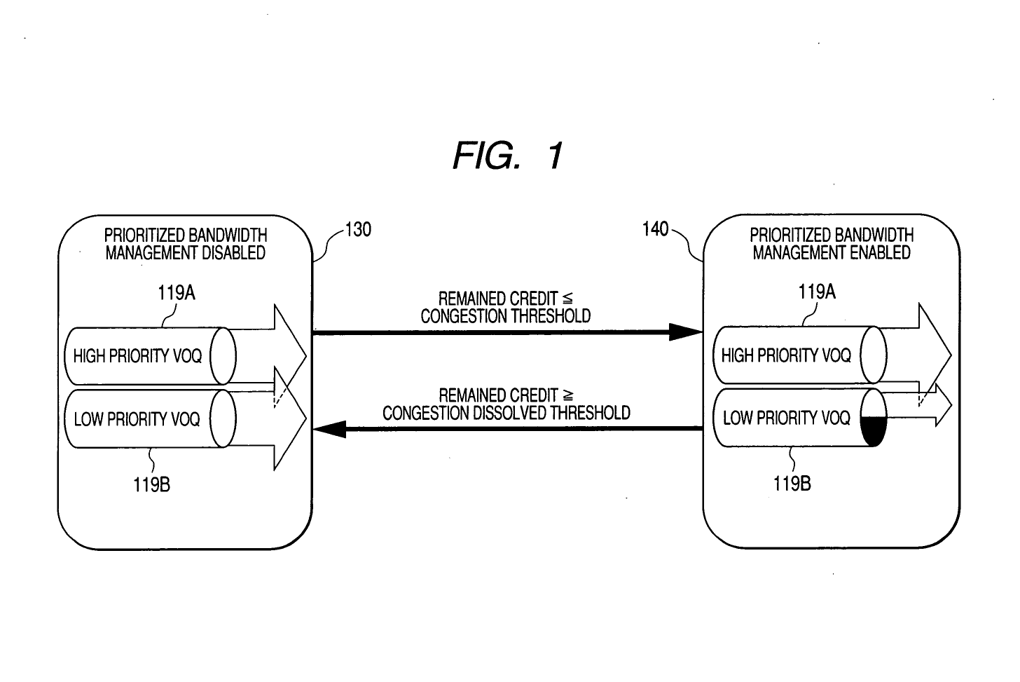

Now, a prioritized bandwidth management method for a switch fabric, according to the invention, is described hereinafter with reference to FIG. 1. In FIG. 1, both a status 130, and a status 140 indicate VOQs for a certain destination by the priority among the VOQs in FIG. 2. Further, the status 130 expresses a status of prioritized bandwidth management disabled, and the status 140 expresses a status of prioritized bandwidth management enabled. Further, if there exists data in the VOQs with plural priorities, high priority VOQ is preferentially outputted regardless of whether or not the prioritized bandwidth management is enabled. Herein, in order to simplify description, it is assumed that there exist only two VOQs, a high priority (QoS1) VOQ 119A, and a low priority (QoS0) VOQ 119B.

In the status 130, data output bandwidths of the VOQs 119A, 119B are not restricted owing to priority. For this reason, in the status 130, data of either the VOQ 119A, or the VOQ 119B can be outputted without restrictions imposed on bandwidth. With the switch 200 in FIG. 2, since it is possible to make full use of switching bandwidths of the switch fabric regardless of priority if the destination is in a non-congestion state, the status 130 is preferable. However, if a certain destination is in a congestion state, that is, if, for example, low priority data is always transmitted from the transmitting source 0 to the destination 0, and high priority data is always transmitted from the transmitting source 1 to the destination 0, in FIG. 2, the switch 200 evenly outputs data against all inputs on a destination-by-destination basis, so that it appears that the high priority data, and the low priority data make even use of switching bandwidths as observed from the destination 0. In consequence, there arises a problem that the high priority data cannot be passed at low delay or high throughput.

In the status 140, the data output bandwidths of the VOQs 119A, 119B are restricted according to the priority. More specifically, the data output bandwidth of the VOQ 119A is not restricted while the data output bandwidth of the VOQ 119B is restricted. More commonly, data output bandwidth of the highest priority VOQ is not restricted, and data output bandwidths of other VOQs with low priority are restricted.

With the switch 200 in FIG. 2, if a destination is in a congestion state, the high priority data can make much use of the switching bandwidths of the switch fabric against the destination, the status 140 is preferable. A point to be noted, however, is that if the status 140 shown in FIG. 1 is maintained all the time, the output of the low priority data is restricted even if a certain destination is in a non-congestion state when only low priority data exists as previously described in connection with the background technology. As a result, there arises the problem that the switching bandwidths of the switch fabric cannot be fully utilized when only the low priority data exists.

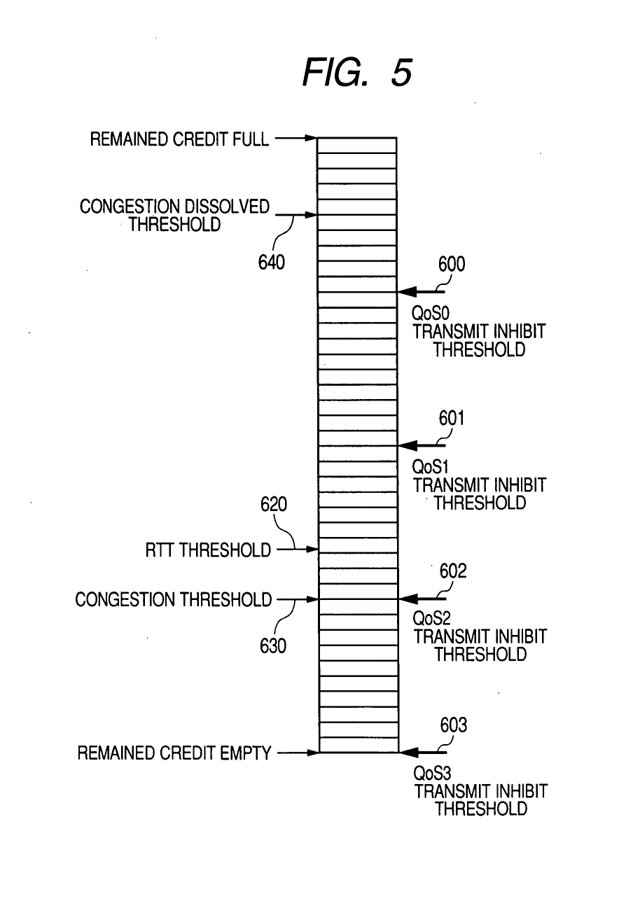

Accordingly, with the invention, detection on whether a certain destination in the switch fabric is in a congestion state, or the congestion state is dissolved is made with the aid of remained credits of the destination, thereby changing over between the status of prioritized bandwidth management enabled and the status of the prioritized bandwidth management disabled. This method is described hereinafter with reference to FIGS. 5 to 8.

First, as previously described with reference to FIG. 4, it is possible to detect a destination where congestion has occurred by observing remained credits by the destination, on the credit tables 120 of the respective transmitting source nodes 100. FIG. 5 is a schematic illustration in the form of a graph showing the number of remained credits of a destination, on the credit table 120. There are provided an RTT threshold 620, a congestion threshold 630, a congestion dissolved threshold 640, and transmit inhibit thresholds 60X on a priority-by-priority basis (with the present embodiment, 4-level priorities QOSX are shown by way of example, and X=0 to 3) against the number of the remained credits. In FIG. 5, a longitudinal direction indicates the number of the remained credits, one square representing one credit, and explanation is given hereinafter on the assumption that the upper the square is located, the greater the number of the remained credits is in value.

The RTT threshold 620 refers to the number of the credits, corresponding to a data length transmittable during an interval from when the transmitting source node 100 transmits data to the switch 200 until when a recovery credit from the switch 200 reaches the transmitting source node 100. In the case of continuation of data transmit from only one transmitting source node 100 to a certain destination node 300, the number of the remained credits coincides with the RTT threshold 620.

The congestion threshold 630 is at a value not higher than the RTT threshold 620 in FIG. 5. In the case of concurrent continuation of data transmit from plural transmitting source nodes 100 to a certain destination node 300, the number of the remained credits is below the congestion threshold 630, so that occurrence of congestion can be assumed. When a detection on congestion is carried out with the switch according to the conventional technology, there used to be a problem in that the switch needs to have special workings for generating a command, and since it takes some time for the command to reach the transmitting side node, this method somewhat lacks in quick responsiveness. The method according to the invention has an advantage in that since the transmitting source node 100 executes a detection on congestion by referring to the number of the remained credits, there is no need for the switch having special workings for the command, and the method has faster responsiveness as compared with the case of the conventional technology.

When a congestion occurs, setting of the transmit inhibit thresholds 60X (X=0 to 3) on a priority-by-priority basis are enabled. Each of data units with respective priorities can be outputted only if the number of the remained credits, not less than the transmit inhibit threshold 60X (X=0 to 3), is left out. Assuming that the higher an X value, the higher the priority is, the higher the X value, the smaller the transmit inhibit threshold 60X is rendered. At least in the case of the highest priority (QoS3), transmit should be possible until the credits are used up, and in FIG. 5, the transmit inhibit threshold 60X is caused to match the lowest side of the graph showing the number of the remained credits.

The congestion dissolved threshold 640 refers to a threshold at which a congestion state is assumed as dissolved. If data transfer to a relevant destination is interrupted, and return of the recovery credit from the switch 200 continues, the number of the remained credits will exceed the congestion dissolved threshold 640. At this point in time, setting of the transmit inhibit thresholds 60X (X=0 to 3) on the priority-by-priority basis are disabled. In general, the congestion dissolved threshold 640 is at a value greater than any of the transmit inhibit thresholds 60X (X=0 to 3) on the priority-by-priority basis.

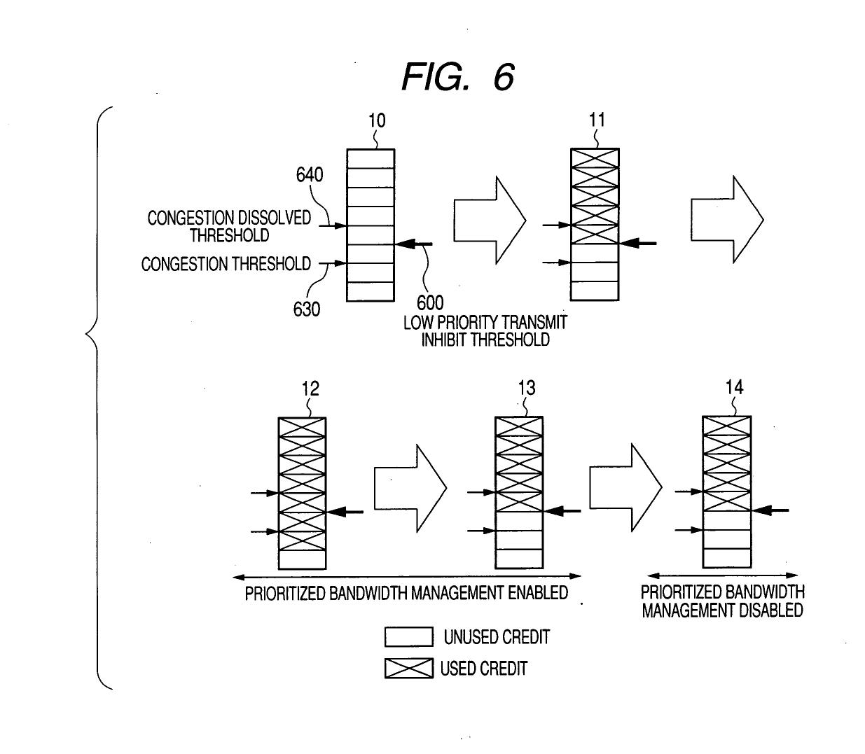

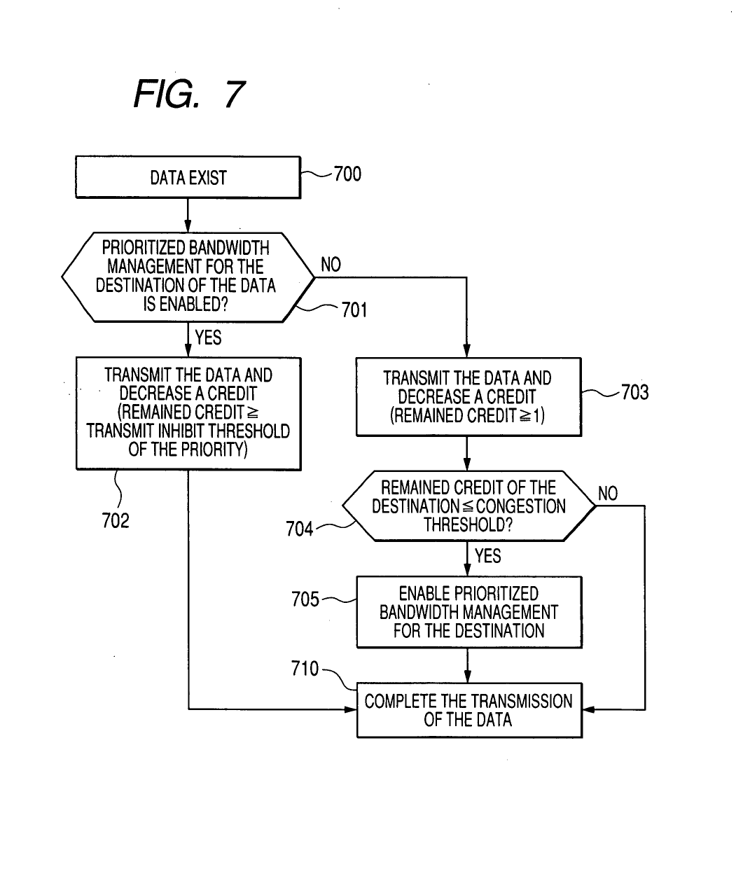

Now, the prioritized bandwidth management method according to the invention is described hereinafter with reference to FIG. 6, in which priorities are set to only two levels by simplifying a configuration in FIG. 5 and a flow chart in FIG. 7. A status 10 shown in FIG. 6 is a status where all credits at a certain destination are unused as yet, that is, the number of remained credits is eight. When data transmit to the destination is continued, the number of the credits in use will increase as shown in a status 11 while the number of the remained credits will keep decreasing. However, up until then, the prioritized bandwidth management is disabled, and every time data to be transmitted to the destination arrives, operation proceeds from steps 700→701→703 in the flow chart of FIG. 7. In step 704, the number of the remained credits is not short of the congestion threshold as yet, so that the operation proceeds to step 710, whereupon the operation is completed. That is, data arriving at the destination every time is sent out to the switch 200, and credits at the destination are decreased accordingly.

If, in the middle of continuation of data transmit from a transmitting source to a relevant destination, another transmitting source as well starts data transmit to the same destination, return of a credit to the transmitting source comes to be interrupted, so that the number of the remained credits will be short of the congestion threshold as shown in a status 12 in FIG. 6. This status triggers prioritized bandwidth management of the relevant destination to be enabled. The operation proceeds from step 704 to step 705 in the flow chart of FIG. 7, thereby enabling the prioritized bandwidth management. As for data after such a change in management status, since the operation proceeds from the step 701 to the step 702, a decision on whether the data is transmitted or not is made according to a determination made in the step 702. More specifically, the number of the remained credits at that point in time is compared with a transmit inhibit threshold set against the priority of the data, and if the former is not less than the latter, the data is transmitted, decreasing a credit. That is, management according to the priority is added to the data transmit from the transmitting source to the relevant destination. With the example shown in FIG. 6, data transmit for low priority data is inhibited before the number of the remained credits of the relevant destination exceeds a low priority transmit inhibit threshold 600, that is, before a status 13 in FIG. 6 is reached. On the other hand, since a transmit inhibit threshold for high priority data is set to the lowest value (remained credits: empty), the high priority data is transmitted every time as long as there exists a credit.

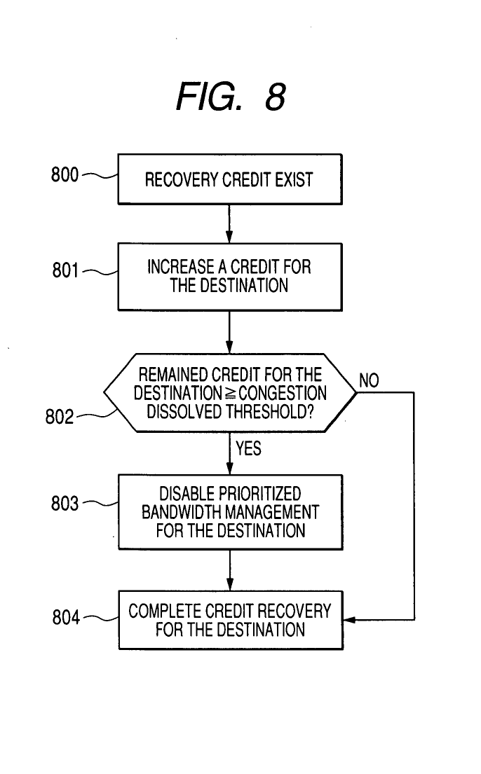

If data output from the relevant transmitting source is interrupted, and return of the recovery credit of the relevant destination to the relevant transmitting source continues, the number of the remained credits exceeds the congestion dissolved threshold 640, whereupon a status 14 in FIG. 6 is reached. This status triggers the prioritized bandwidth management of the relevant destination to be disabled. FIG. 8 is a flow chart showing operation for changing a management status in a congestion recovery process. Upon return of a recovery credit from the switch 200 in step 800, an increase in the number of the remained credits occurs at a relevant destination in step 801. As a result, if it is determined in step 802 that the number of the remained credits reaches the congestion dissolved threshold 640, the operation proceeds to step 803, thereby disabling the prioritized bandwidth management for the relevant destination.

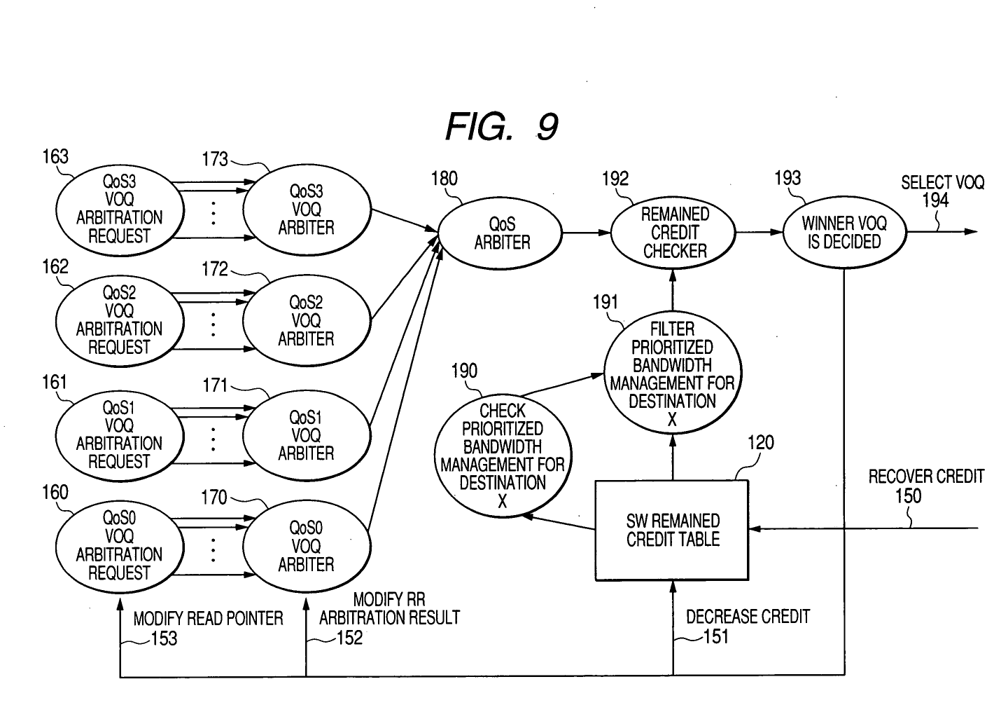

Now, in FIG. 9, there is shown one embodiment of a VOQ selection logic at the transmitting source node 100, for executing the prioritized bandwidth management while changing over between the disabling and the enabling of the prioritized bandwidth management according to the invention.

The transmitting source node 100 has the number of the VOQs, expressed by the product of the number of priorities, and the number of destinations. VOQ arbiters 170 to 173 each gather an output arbitration request from the respective VOQs on a priority-by-priority basis, selecting the VOQs serving as candidates, respectively, on the basis of an algorithm of round robin, and so forth.

Subsequently, one of the select candidates VOQs, having the highest priority, is selected by a QoS arbiter 180. After the selection, remained credits at destinations for the select VOQs are checked by a remained credit checker 192. The remained credits are read from the credit table 120, and if the prioritized bandwidth management for the relevant destination is enabled, checking is executed with the use of a value, by which the number of the remained credits, associated with the priority transmit inhibit threshold, is decreased according to priority. If the prioritized bandwidth management for the relevant destination is disabled, checking is executed by making use of a value read from the credit table 120, as it is. When the remained credit checker 192 determines that there remains a credit, it follows that the select VOQs have won in output arbitration, so that data output can be executed as long as the credit remain. The credit is recovered upon return of the recovery credit from the switch (step 150).

Every time a winner VOQ outputs data, the number of the remained credits for the relevant destination, on the credit table 120, is decreased (step 151), and the respective VOQ arbiters 170 to 173, on the priority-by-priority basis, modify results of the algorithm as selected, that is, decrease a priority-select output-number one by one, for example, in the case of round robin management (step 152). Further, a read pointer for the winner VOQ is modified to prepare for reading of subsequent data (step 153).

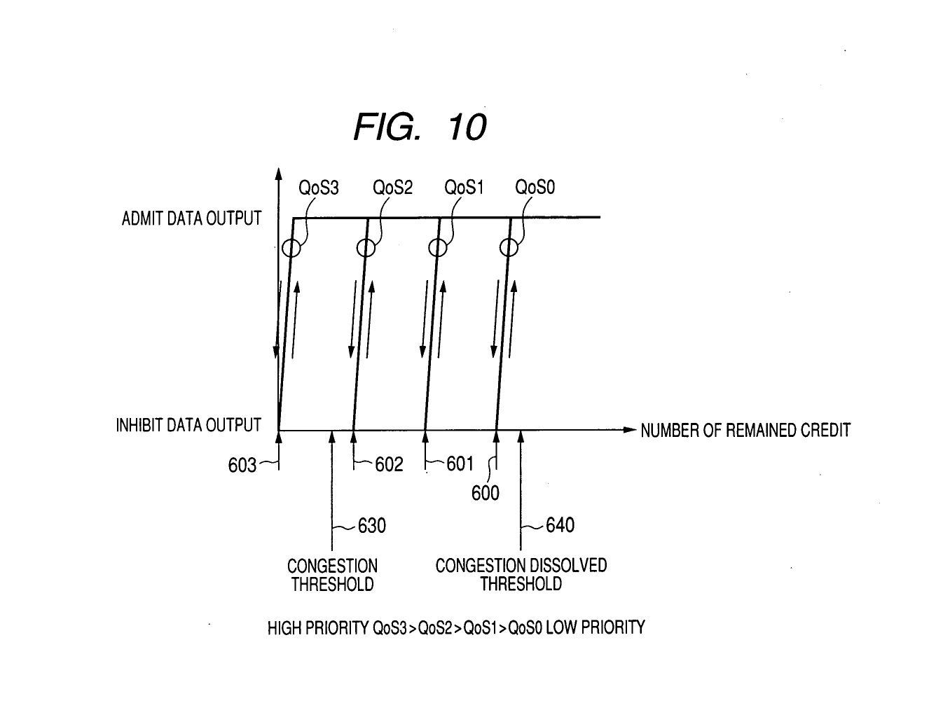

Now, in FIG. 10, there is shown a relationship between data output from the VOQs at the transmitting source node 100, described in the foregoing, and the number of the remained credits. In the figure, the horizontal axis indicates the number of the remained credits, and the vertical axis indicates admit/inhibit of the data output (admit if upward in direction, inhibit if downward in direction) while a positional relationship among the congestion threshold 630, the congestion dissolved threshold 640, and the transmit inhibit thresholds 60X on the priority-by-priority basis in the case of occurrence of congestion (in the case of 4 classes of priorities, X=0 to 3), as shown in FIG. 5, is indicated along the horizontal axis.

In the case of non-congestion, the data output from the VOQ is possible regardless of the priority of data as long as there exists not less than one remained credit. That is, a management status will be the same as that for QoS3 shown in FIG. 10. Meanwhile, once the number of the remained credits falls short of the congestion threshold 630, the prioritized bandwidth management is enabled, and the transmit inhibit thresholds 600, 601, 602, 603, on the priority-by-priority basis, will be enabled. In this status, respective management statuses of QoS0 to QoS3, in FIG. 10, are set according to the priority of data. More specifically, if the number of the remained credits is not less than the transmit inhibit thresholds 60X on the priority-by-priority basis when the case of the number of priorities is X, the data output from the VOQ is possible, however, if the former falls short of the latter, the data output is inhibited. Further, as for a destination that has fallen into a congestion state, the prioritized bandwidth management remains enabled before data output to the destination is once completed, and the number of the remained credits exceeds the congestion dissolved threshold 640.

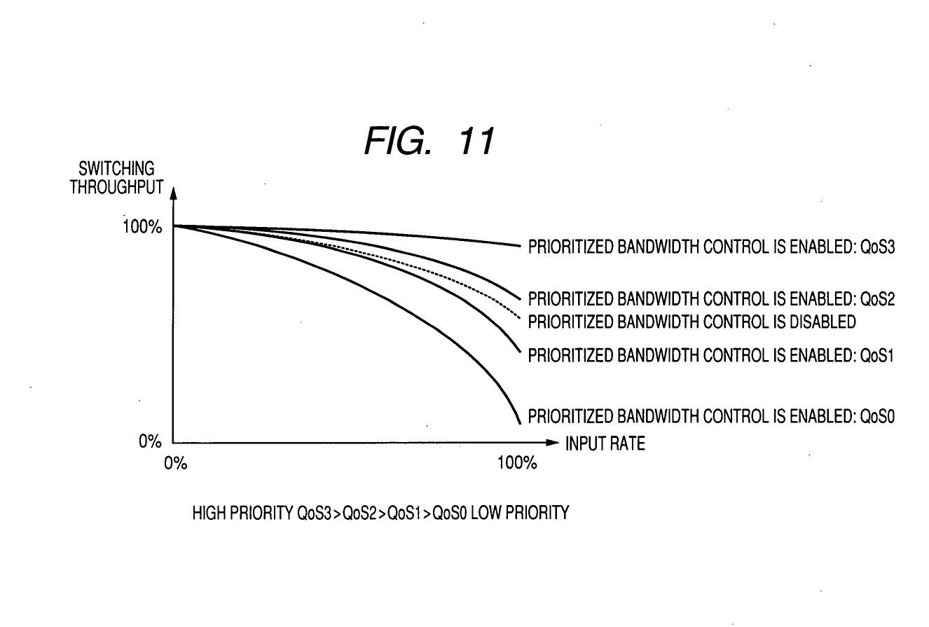

FIG. 11 shows a general relationship between a rate of all inputs of the switching fabric (100% indicates continuous data input without interruption to the transmitting source node 100), and a switching throughput, in the respective cases of the prioritized bandwidth management being disabled, and the prioritized bandwidth management being enabled, on the priority-by-priority basis. Further, in this case, it is assumed that a destination is random, and there can be the case of bias toward a specific destination.

In the case where the prioritized bandwidth management is disabled, as an input rate approaches 100%, so an effective switching throughput, that is, a switch rate of data keeps decreasing. On the other hand, in the case where the prioritized bandwidth management is enabled, high priority data can maintain the effective switching throughput substantially close to 100%, in other words, the switch rate of data can be maintained even if the input rate approaches 100% provided that data with plural priorities mixed therein is inputted. To put it another way, it follows that the effective switching throughput of high priority data is enhanced by decreasing the effective switching throughput of low priority data. A method of changing over between the enabling of the prioritized bandwidth management, and the disabling of the prioritized bandwidth management is as previously described with reference to FIGS. 5 to 8, and FIG. 10.

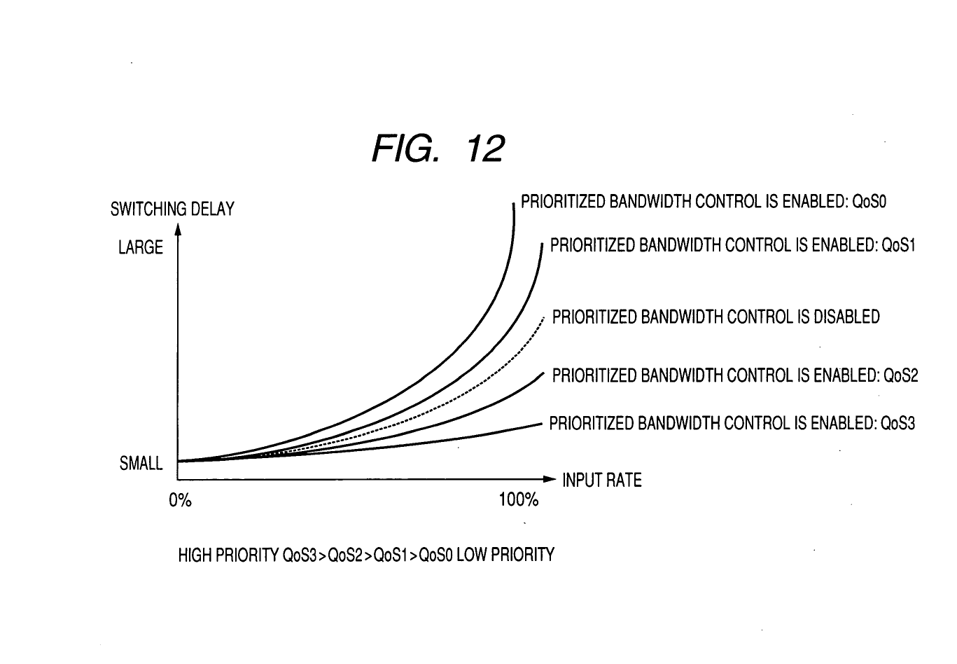

FIG. 12 shows a state of switching delay at the switch fabric, according to priority. In the case where the prioritized bandwidth management is disabled, as the input rate approaches 100%, the delay keeps increasing. On the other hand, in the case where the prioritized bandwidth management is enabled, high priority data can maintain a substantially constant switching delay even if the input rate approaches 100% provided that data with the plurality of the priorities mixed therein is inputted. Or to put it another way, the switching delay of the high priority data is decreased by increasing the switching delay of the low priority data.

The first embodiment of a method for executing the prioritized bandwidth management by changing over between the enabling of the prioritized bandwidth management, and the disabling of the prioritized bandwidth management, according to the invention, has been described in detail as above. It is to be pointed out, however, that the present description is concerned with nothing but one embodiment of the invention, and that various changes and modifications may be made in the invention without departing from the spirit and scope thereof.

### Second Embodiment

In the case of the first embodiment, in transmission from the transmitting source node 100, unicast to a single destination node 300 is presumed, however, even in the cast of multi-cast to plural destination nodes 300, it is possible to execute similar prioritized bandwidth management, which is described hereinafter as a second embodiment of the invention.

When supporting the multi-cast, VOQs for exclusive use in the multi-cast, in number corresponding to the number of priorities to be handled, are prepared in addition to the VOQs of each of the transmitting source nodes 100, according to the first embodiment, for use in the unicast.

Processing is basically the same as that for the first embodiment, however, in the case of a transmitting source node 100 selecting multi-cast data, remained credits for all destinations corresponding to the transmitting source node 100 are referred to on the credit table 120 shown in FIG. 2, and data can be outputted only when there exists a remained credit. At this point in time, the transmitting source node 100 transmits to a switch 200 data with multi-cast information, that is, information on plural destinations, added thereto. The switch 200 copies data on the basis of the multi-cast information before transmitting copied data to all destination nodes 300 as designated.

When prioritized bandwidth management is enabled for even one of the destinations corresponding to the transmitting source node 100, processing is executed on the assumption that the prioritized bandwidth management is enabled for all the destinations.

It is to be pointed out that the present description is concerned with nothing but one embodiment of the invention, and that various changes and modifications may be made in the invention without departing from the spirit and scope thereof.

### Third Embodiment

With the first and second embodiments, respectively, the remained credits of the switch 200, to be controlled by the transmitting source node 100 in FIG. 2, are controlled by the destination-by-destination basis. With a third embodiment, there is described a method whereby the remained credits are shared by plural destinations, predicated on the first and second embodiments, respectively. The present embodiment has a merit in that prioritized bandwidth management can be implemented with the use of a relatively small-scale logic even if use is made of a switch 200 with multiple-ports.

When a receive-buffer independent of respective destinations is provided for every transmitting source node 100 within the switch 200, even if a certain destination is in a congestion state, data transmit will be enabled without other destinations being subjected to the effect of the congestion at all. However, there arises a problem that a chip area of a switching device making up the switch 200 becomes huge in size with the square of the number of the ports. Methods for preventing the switch from becoming huge include a method for sharing the receive-buffers of the switch 200.

As a first one of the method for sharing the receive-buffer of the switch 200, there is a method whereby the receive-buffer of the switch 200 is shared by plural the transmitting source nodes 100, and as a second one of the method, there is a method whereby the receive-buffer of the switch 200 is shared by plural the destinations for every transmitting source node 100. With the first method, an available capacity of the receive-buffer, that is, the number of remained credits will be changed according to transmit states of other transmitting source nodes 100, thereby rendering management complicated, so that the first method is not preferable. Accordingly, there is described herein a prioritized bandwidth management method for the switch fabric with reference to the second method.

With the method whereby the receive-buffer of the switch 200 is shared by the plurality of the destinations for every transmitting source node 100, control of remained credits on the credit table 120 shown in FIG. 2 is executed not by the individual destination, but the remained credits is controlled one by one by the destinations that share the receive-buffer of the switch 200. For example, in the case where the switch 200 is a switch with 8 ports, and all exit ports are independently controlled, the credit table 120 controls eight remained credits, in total, on the destination-by-destination basis. On the other hand, in the case where exit ports 0 to 1, 2 to 3, 4 to 5, and 6 to 7, respectively, share the receive-buffer in the switch 200 with 8 ports, the credit table 120 controls one remained credit for destinations 0 to 1, one remained credit for destinations 2 to 3, one remained credit for destinations 4 to 5, and one remained credit for destinations 6 to 7, that is, four remained credits, in total.

When a certain destination is lacking in remained credit, and the number of the remained credits falls short of the congestion threshold 630 shown in FIG. 5, the prioritized bandwidth management is enabled for the relevant destination, together with other destinations having the remained credits in common with the relevant destination. The prioritized bandwidth management is disabled when data transmit to the relevant destination, and the other destinations having the remained credits in common with the relevant destination is interrupted, and the number of the remained credits exceeds the congestion dissolved threshold 640.

The present embodiment is suitable for application, particularly in the case of making use of the switch 200 with the multiple-ports, in FIG. 2. This is because the more the number of ports of the switch is, the harder it will be to mount the receive-buffer completely independent by the transmitting source, and by the destination, owing to physical constraints, so that the method whereby the receive-buffer of the switch 200 is shared by the plurality of the destinations for every transmitting source node 100 as previously described is effective. Management of the credit table 120, by the transmitting source node 100, is rendered easier because the control logic is simplified to the extent that the destinations are converged. Effects of congestion at one port will affect other output ports sharing the destinations, resulting in deterioration in throughput, however, such adverse effects can be held in check to the minimum by decreasing the number of the ports sharing the destinations to an extent.

Further, it is to be pointed out that the present description is concerned with nothing but one embodiment of the invention, and that various changes and modifications may be made in the invention without departing from the spirit and scope thereof.

### Fourth Embodiment

Lately, with many network transfer units such as routers, switches (L2 switch, L3 switch, etc.) and so forth, use is made of an Ethernet frame (hereinafter called a packet) of a variable length, as transfer data, and the network transfer unit having the switch fabric often divides a packet into cells of a fixed length to be subsequently transferred. That is, input data to the switch fabric appears to be made up of plural data units. Accordingly, as a fourth embodiment, there is shown an application method of the invention in the case of data to be handled being a packet with respect to the first to third embodiments, respectively.

With the fourth embodiment, the VOQs of the transmitting source node 100, shown in FIG. 2, controls the packet as data. And, when the transmitting source node 100 reads a packet from the VOQ, and transmits the packet to the switch 200, the packet is divided into not less than one cell. The number of the remained credits on the credit table 120 is decreased by the number of cells actually sent out.

In this case, in the middle of a certain packet being divided into cells to be then transferred to the switch 200, it can happen that the number of remained credits for a relevant destination falls short of the congestion threshold 630 shown in FIG. 5. At that point in time, the prioritized bandwidth management for the relevant destination is enabled as described with reference to the first to third embodiments, respectively, however, the packet has been converted into the cells only halfway through. In such cases, only the cells generated from the packet may be sent out as it is without restrictions according to QOSX, the transmit inhibit thresholds 60X (X=0 to 3).

Further, all the packets successfully taken out of the VOQs while the prioritized bandwidth management for the relevant destination is enabled may be converted into the cells without the restrictions according to QOSX, the transmit inhibit thresholds 60X (X=0 to 3), to be then transmitted. Otherwise, as for the packets successfully taken out of the VOQs while the prioritized bandwidth management for the relevant destination is enabled, transmission of a portion of cells thereof, subjected to the restrictions according to QOSX, the transmit inhibit thresholds 60X (X=0 to 3), is once stopped, and only a portion of the cells, not subjected to the restrictions according to QOSX, the transmit inhibit thresholds 60X (X=0 to 3), may be transmitted.

Still further, it is to be pointed out that the present description is concerned with nothing but one embodiment of the invention, and that various changes and modifications may be made in the invention without departing from the spirit and scope thereof.

### Fifth Embodiment

The first to fourth embodiments have been described on the premise that the switch 200 of the switch fabric is a single-stage switch. However, in order to significantly increase the number of ports to be handled, it is necessary to make up a multi-stage connecting net of not less than three stages, such as a cross net, Venetian net, and so forth, using plural switching devices. Even in such cases, the same prioritized bandwidth management as shown in the first to fourth embodiments, respectively, can be implemented, and points to be modified for this purpose are described hereinafter as a fifth embodiment of the invention.

With the fifth embodiment, remained credits of the switch 200, handled by the transmitting source node 100, indicate an available buffer-capacity of a switching device positioned in a stage closest to the transmitting source node 100. It is unnecessary for the transmitting source node 100 to control an available buffer-capacity of a switching device in a second stage and onwards, and remained credits of a switching device in a N-th stage (N is an integer not less than 2) is generally controlled by a switching device in a (N−1)-th stage. Enabling and disabling of the prioritized bandwidth management, and a prioritized bandwidth management method for the transmitting source node 100, in respective statuses, may be executed as with the case of the first embodiment. More specifically, in a switching system making up the multi-stage connecting net with the use of the plurality of the switching devices, the number of the remained credits is controlled as an available buffer-capacity of a switching device positioned in a stage closest to the transmitting source node 100 within the multi-stage connecting net, on a destination-by-destination basis, and on the basis of such information only, changeover between the enabling and the disabling of the prioritized bandwidth management is executed.

Yet further, it is to be pointed out that the present description is concerned with nothing but one embodiment of the invention, and that various changes and modifications may be made in the invention without departing from the spirit and scope thereof.

The prioritized bandwidth management method according to the invention can be used in a system requiring data switch by utilizing a large capacity line. It is conceivable to make use of the prioritized bandwidth management method according to the invention for the switch fabric in the network transfer units, represented by the router, and the switch, and for the switch fabric in the network transfer units such as the server, and the storage device by way of example.

What is claimed is:

1. A prioritized bandwidth management method for a switch fabric including a plurality of transmitting source nodes each having not less than two output queues by the priority on a destination-by-destination basis, a switch for evenly distributing data units delivered from the plurality of the transmitting source nodes on the destination-by-destination basis, and a plurality of destination nodes for receiving the data units from the switch, said prioritized bandwidth management method for the switch fabric, the method comprising the steps of:
the respective transmitting source nodes assuming that a relevant destination is in a congestion state when an available capacity of a receive-buffer of the switch, controlled by the respective transmitting source nodes, on the destination-by-destination basis, falls short of a set congestion threshold, thereby restricting data output from the output queues by the priority to the relevant destination up to a preset bandwidth according to priority, and
the respective transmitting source nodes assuming that the congestion state of the relevant destination is dissolved when the available capacity of the receive-buffer of the switch, on the destination-by-destination basis, exceeds the set congestion threshold, thereby dissolving restriction on the bandwidth, according to the priority.

2. A prioritized bandwidth management method for a switch fabric including a plurality of transmitting source nodes each having not less than two output queues by the priority on a destination-by-destination basis, a plurality of switches, each for evenly distributing data units divided, and delivered from the plurality of the transmitting source nodes, respectively, on the destination-by-destination basis, and a plurality of destination nodes for receiving the data units divided from the respective switches, all the transmitting source nodes and all the destination nodes having connection with all of the plurality of the switches, respectively, said prioritized bandwidth management method for a switch, the method comprising the steps of:
the respective transmitting source nodes assuming that a relevant destination is in a congestion state when an available capacity of a receive-buffer of each of the switches, controlled by the respective transmitting source nodes, on the destination-by-destination basis, falls short of a set congestion threshold, thereby restricting data output from the output queues by the priority to the relevant destination up to a preset bandwidth according to priority, and
the respective transmitting source nodes assuming that the congestion state of the relevant destination is dissolved when the available capacity of the receive-buffer, on the destination-by-destination basis, exceeds the set congestion threshold, thereby dissolving restriction on the bandwidth, according to the priority.

3. A prioritized bandwidth management method for a switch fabric, according to claim 1, wherein in the case of data from a transmitting source node being multi-cast data to be distributed to a plurality of destinations, if at least one of the destinations is in the congestion state, the data output from the output queues by the priority to all the destinations is restricted up to the preset bandwidth according to the priority.

4. A prioritized bandwidth management method for a switch fabric, according to claim 1, wherein each transmitting source node manages available capacities of receive-buffers, each receive buffer being common for plural destinations.

5. A prioritized bandwidth management method for a switch fabric, according to claim 1, wherein when the data output from the output queues by the priority is restricted up to the preset bandwidth according to the priority, data of a variable length from the transmitting source node is divided into data units of a fixed length, and the data units of the fixed length are outputted by only a portion thereof, not subjected to the restriction on the bandwidth.

6. A prioritized bandwidth management method for a switch fabric, according to claim 1, wherein when the data output from the output queues by the priority is restricted up to the preset bandwidth according to the priority, if the header of data of a variable length from the transmitting source node is successfully taken out, the data of the variable length is divided into data units of a fixed length as long as there is the available capacity of the receive-buffer of the switch, on the destination-by-destination basis, and the data units are outputted without the restriction on the bandwidth.

7. A prioritized bandwidth management method for a switch fabric, according to claim 1, wherein a switching stage is made up of a plurality of switching devices along every path of data from a transmitting source to a destination, and the available capacity of the receive-buffer of the switch, controlled by the transmitting source, on the destination-by-destination basis, is controlled by the switch device positioned in a stage closest to the transmitting source node on the destination-by-destination basis.

8. A switching system comprising:
a switch fabric including a plurality of transmitting source nodes each having not less than two output queues by the priority on a destination-by-destination basis, a switch for evenly distributing data units delivered from the plurality of the transmitting source nodes on the destination-by-destination basis, and a plurality of destination nodes for receiving the data units from the switch; and
a prioritized bandwidth management means for changing over between enabling and disabling of prioritized bandwidth management of the switch fabric on the basis of information showing the congestion state of the respective destination nodes.

9. A prioritized bandwidth management method for a switch fabric comprising a plurality of transmitting source nodes each having not less than two output queues by the priority on a destination-by-destination basis, a switch for evenly distributing data units delivered from the plurality of the transmitting source nodes on the destination-by-destination basis, and a plurality of destination nodes for receiving the data units from the switch, wherein changeover between enabling and disabling of prioritized bandwidth management is executed only on the basis of information on an available capacity of a receive-buffer of a switching device positioned in a stage closest to the respective transmitting source nodes.

10. A prioritized bandwidth management method for a switch fabric comprising a plurality of transmitting source nodes each having not less than two output queues by the priority on a destination-by-destination basis, a switch for evenly distributing data units delivered from the plurality of the transmitting source nodes on the destination-by-destination basis, and a plurality of destination nodes for receiving the data units from the switch,
wherein in the case where prioritized bandwidth management is enabled, a switch rate of high priority data is enhanced above that of low priority data, and
wherein in the case where the prioritized bandwidth management is disabled, a given switch rate of data is maintained regardless of priority.

11. A prioritized bandwidth management method for a switch fabric comprising a plurality of transmitting source nodes each having not less than two output queues by the priority on a destination-by-destination basis, a switch for evenly distributing data units delivered from the plurality of the transmitting source nodes on the destination-by-destination basis, and a plurality of destination nodes for receiving the data units from the switch,
wherein in the case where prioritized bandwidth management is enabled, switching delay of high priority data is rendered smaller than that of low priority data, and
wherein in the case where the prioritized bandwidth management is disabled, a given switching delay of data is maintained regardless of priority.
